(19) United States
(12) Patent Application Publication
(10) Pub. No.: US 2025/0350762 A1
(43) Pub. Date: Nov. 13, 2025

(54) IMAGE PRE-ANALYSIS METHOD AND SYSTEM, APPARATUS, AND STORAGE MEDIUM

(71) Applicant: SHANGHAI BILIBILI TECHNOLOGY CO., LTD., Shanghai (CN)

(72) Inventors: Dapeng CHEN, Shanghai (CN); Tianxiao YE, Shanghai (CN)

(21) Appl. No.: 19/196,659

(22) Filed: May 1, 2025

(30) Foreign Application Priority Data
May 8, 2024 (CN) 202410565727.8

(51) Int. Cl. H04N 19/567; H04N 19/109; H04N 19/139; H04N 19/176; H04N 19/54; H04N 19/56

(52) U.S. Cl. CPC H04N 19/567; H04N 19/109; H04N 19/139; H04N 19/176; H04N 19/54; H04N 19/56

(57) ABSTRACT

The application discloses an image pre-analysis method, applied to a pre-analysis module of an encoder. The method includes: performing downsampling on a to-be-processed image, and dividing the to-be-processed image into square blocks of a same size; performing inter-frame prediction on a current block based on a single-motion-vector mode, to determine a best cost and a corresponding prediction direction; performing inter-frame prediction on the current block based on a pseudo-affine transformation mode by using the prediction direction as a search direction of the pseudo-affine transformation mode, to obtain an affine transformation cost; and comparing a value of the best cost with a value of the affine transformation cost, and determining, based on a comparison result, a best mode for performing pre-analysis inter-frame prediction on the current block. The application further discloses an image pre-analysis system, an electronic apparatus, and a computer-readable storage medium.

### CROSS-REFERENCE TO RELATED APPLICATION

This application claims priority to Chinese Patent Application No. 202410565727.8 filed on May 8, 2024, which is incorporated herein by reference in its entirety.

### TECHNICAL FIELD

The application relates to the field of video coding technologies, and in particular, to an image pre-analysis method and system, an electronic apparatus, and a computer-readable storage medium.

### BACKGROUND

With continuous evolution of a video coding standard, accuracy of a prediction method in a current video coding process is significantly improved compared with the past. A versatile video coding (VVC) standard is used as an example. A proposed affine transformation mode enables inter-frame prediction to describe motion processes of various deformation and rotation types, which significantly reduces bit quantity overheads during compression of such motion manners, thereby significantly contributing to improvement of compression efficiency.

However, in pre-analysis modules of most commercial encoders, a practice in a previous-generation standard is still used, and motion is described in a conventional single-motion-vector manner, and the conventional single-motion-vector manner is used as a basis for calculation of a propagation cost. When the practice is used in a latest-generation standard, an inter-frame prediction cost calculated by the pre-analysis modules and an inter-frame prediction cost calculated by a primary encoder module are significantly different. Consequently, effects such as scene detection, an adaptive frame type, a cutree, and an MCTF that are involved in the pre-analysis modules are relatively poor.

### SUMMARY

A main objective of the application is to provide an image pre-analysis method and system, an electronic apparatus, and a computer-readable storage medium, to resolve a problem of how to reduce a difference between an inter-frame prediction result calculated by a pre-analysis module and an inter-frame prediction result calculated by a primary encoder module in an encoder of a new standard.

To implement the foregoing objective, an embodiment of the application provides an image pre-analysis method, applied to a pre-analysis module of an encoder, wherein the method includes:
performing downsampling on a to-be-processed image, and dividing the to-be-processed image into square blocks of a same size;
performing inter-frame prediction on a current block based on a single-motion-vector mode, to determine a best cost and a corresponding prediction direction;
performing inter-frame prediction on the current block based on a pseudo-affine transformation mode by using the prediction direction as a search direction of the pseudo-affine transformation mode, to obtain an affine transformation cost; and
comparing a value of the cost with a value of the affine transformation cost, and determining, based on a comparison result, a mode for performing pre-analysis inter-frame prediction on the current block.

Optionally, the performing inter-frame prediction on a current block based on a single-motion-vector mode, to determine a best cost and a corresponding prediction direction includes:
performing motion estimation on the current block based on the single-motion-vector mode, to determine rate distortion costs predicted in forward, backward and bi-directional; and
comparing the rate distortion costs in each prediction direction to obtain the best cost and a prediction direction corresponding to the best cost.

Optionally, the performing inter-frame prediction on the current block based on a pseudo-affine transformation mode by using the prediction direction as a search direction of the pseudo-affine transformation mode, to obtain an affine transformation cost includes:
dividing the current block into four square sub-blocks of a same size;
performing motion estimation on each sub-block in a reference frame based on the search direction, to obtain a corresponding final motion vector;
obtaining, based on final motion vectors of the four sub-blocks, a predicted block corresponding to the current block in the reference frame; and
obtaining the affine transformation cost based on a difference between the current block and the predicted block.

Optionally, the performing motion estimation on each sub-block in a reference frame based on the search direction, to obtain a corresponding final motion vector includes:
determining search start points for first three sub-blocks, and respectively performing motion estimation on the three sub-blocks in the reference frame by using the search start points, to obtain corresponding reference blocks and coding costs;
determining final motion vectors of the three sub-blocks based on the coding costs; and
obtaining a final motion vector of a fourth sub-block based on the final motion vectors of the three sub-blocks.

Optionally, the determining final motion vectors of the three sub-blocks based on the coding costs includes:
when the coding costs are less than or equal to a specified threshold, using the search start points as the final motion vectors of the sub-blocks.

Optionally, the determining final motion vectors of the three sub-blocks based on the coding costs includes:
when the coding costs are greater than the specified threshold, performing a hexagon-based search based on the search start points, to obtain the final motion vectors of the sub-blocks.

Optionally, the obtaining, based on final motion vectors of the four sub-blocks, a predicted block corresponding to the current block in the reference frame includes:
obtaining four predicted sub-blocks respectively pointed to by the final motion vectors of the four sub-blocks in the reference frame; and
splicing the four predicted sub-blocks to obtain the predicted block corresponding to the current block.

Optionally, the determining, based on a comparison result, a best mode for performing pre-analysis inter-frame prediction on the current block includes:
when the value of the best cost is greater than or equal to the value of the affine transformation cost, determining the best mode is the pseudo-affine transformation mode; and
when the value of the best cost is less than the value of the affine transformation cost, determining that the best mode is the single-motion-vector mode.

In addition, to implement the foregoing objective, an embodiment of the application further provides an image pre-analysis system, applied to a pre-analysis module of an encoder, wherein the system includes:
a division module, configured to perform downsampling on a to-be-processed image, and divide the to-be-processed image into square blocks of a same size;
a first prediction module, configured to perform inter-frame prediction on a current block based on a single-motion-vector mode, to determine a best cost and a corresponding prediction direction;
a second prediction module, configured to perform inter-frame prediction on the current block based on a pseudo-affine transformation mode by using the prediction direction as a search direction of the pseudo-affine transformation mode, to obtain an affine transformation cost; and
a determining module, configured to compare a value of the best cost with a value of the affine transformation cost, and determine, based on a comparison result, a best mode for performing pre-analysis inter-frame prediction on the current block.

To achieve the foregoing objective, an embodiment of the application further provides an electronic apparatus. The electronic apparatus includes a memory, a processor, and an image pre-analysis program stored in the memory and capable of running on the processor. When the image pre-analysis program is executed by the processor, the foregoing image pre-analysis method is implemented.

To implement the foregoing objective, an embodiment of the application further provides a computer-readable storage medium. The computer-readable storage medium stores an image pre-analysis program, and when the image pre-analysis program is executed by a processor, the foregoing image pre-analysis method is implemented.

To implement the foregoing objective, an embodiment of the application further provides a computer program product. The computer program product stores an image pre-analysis program, and when the image pre-analysis program is executed by a processor, the foregoing image pre-analysis method is implemented.

According to the image pre-analysis method and system, the electronic apparatus, and the computer-readable storage medium provided in the embodiments of the application, a pseudo-affine transformation mode applicable to a pre-analysis module is provided. Through simple imitation of a prediction manner of an affine transformation mode of a primary encoder module, a more accurate prediction result is provided in the pre-analysis module, thereby significantly reducing description overheads for a special motion manner, improving consistency between a prediction result of the pre-analysis means and a prediction result of the primary encoder module, improving efficiency of the pre-analysis module, and providing better guidance for behavior of the primary encoder module. In addition, a best mode suitable for performing inter-frame prediction on a current block by the pre-analysis module may be flexibly selected based on comparison between a prediction cost obtained when the current block uses a single-motion-vector mode and a prediction cost obtained when the current block uses the pseudo-affine transformation mode, so as to reduce the prediction cost and improve compression efficiency.

### BRIEF DESCRIPTION OF DRAWINGS

FIG. 1 is a diagram of an architecture of an application environment for implementing embodiments of the application;

FIG. 2 is a flowchart of an image pre-analysis method according to Embodiment 1 of the application;

FIG. 3 is a detailed schematic flowchart of step S204 in FIG. 2;

FIG. 4 is a schematic diagram of four square sub-blocks according to the application;

FIG. 5 is a detailed schematic flowchart of step S2042 in FIG. 3;

FIG. 6 is a schematic diagram of a search start point for each sub-block according to the application;

FIG. 7 is a schematic diagram of a process of obtaining a predicted block according to the application;

FIG. 8 is a schematic flowchart of another form of the image pre-analysis method according to Embodiment 1 of the application;

FIG. 9 is a schematic diagram of a hardware architecture of an electronic apparatus according to Embodiment 2 of the application; and

FIG. 10 is a schematic diagram of modules of an image pre-analysis system according to Embodiment 3 of the application.

### DESCRIPTION OF EMBODIMENTS

To make the objectives, technical solutions, and advantages of the application clearer and more comprehensible, the following further describes the application in detail with reference to the accompanying drawings and embodiments. It should be understood that the specific embodiments described herein are merely used to explain the application but are not intended to limit the application. All other embodiments obtained by a person of ordinary skill in the art based on the embodiments of the application without creative efforts shall fall within the protection scope of the application.

It should be noted that the descriptions such as “first” and “second” in the embodiments of the application are merely used for description, and shall not be understood as an indication or implication of relative importance or an implicit indication of a quantity of indicated technical features. Therefore, a feature defined with “first” or “second” may explicitly or implicitly include at least one feature. In addition, technical solutions in the embodiments may be combined with each other, provided that a person of ordinary skill in the art can implement the combination. When the combination of the technical solutions is contradictory or cannot be implemented, it should be considered that the combination of the technical solutions does not exist and does not fall within the protection scope of the application.

Explanations of terms involved in the application are provided below.

Versatile Video Coding (VVC) standard: also referred to as H.266, MPEG-I Part 3, or a future video coding standard, is a new-generation compression standard for video coding that is jointly formulated by the International Telecommunication Union and the International Organization for Standardization, and is a successor standard of the High Efficiency Video Coding (HEVC) standard, and aims to provide higher compression performance and better video quality.

Affine transformation Mode (Affine Mode): a new inter-frame prediction technology added to the VVC. Compared with a case that only simple displacement motion can be described because only a single motion vector is included in a conventional motion estimation algorithm, the affine transformation mode utilizes motion vectors of two or three control points in a bitstream along with an interpolation-like method to obtain a motion vector of each sub-block in a current coding unit, so as to enable the description of motion behavior such as rotation and scaling, and significantly improve compression efficiency.

Cutree: a coding unit-level quantization parameter adjustment algorithm based on a propagation distortion cost.

Motion-compensated temporal filter (MCTF): a coding tool in an encoder that performs early filtering processing on a video to improve compression efficiency.

Sum of Absolute Transformed Differences (SATD): a standard for measuring a size of a residual signal of a video. After Hadmard (Hadmard) transformation is performed on a difference between two pixel matrices, a sum of absolute values of transformation matrices is calculated to evaluate the difference between the two pixel matrices.

In current various open-source VVC standard encoders, pre-analysis modules generally describe a motion process in the conventional single-motion-vector manner, to calculate an inter-frame prediction cost of a current block, which is then used as a reference for subsequent computations of other modules. In a latest generation of video coding standard VVC, however, a primary encoder module describes motion behavior by using the affine transformation mode during inter-frame prediction. Introduction of this technology causes an extremely large difference between a motion cost predicted by the original pre-analysis module and a prediction result of the primary encoder module, and consequently, a result obtained by the pre-analysis module cannot provide accurate guidance for behavior of the primary encoder module.

Therefore, the application proposes a pseudo-affine transformation mode applicable to a pre-analysis module. Through simple imitation of a prediction manner of an affine transformation mode of a primary encoder module, a more accurate prediction result is provided in the pre-analysis module, thereby significantly reducing description overheads for a special motion manner, improving consistency between a prediction result of the pre-analysis module and a prediction result of the primary encoder module, improving efficiency of the pre-analysis module, and providing better guidance for behavior of the primary encoder module.

The technical solutions proposed in the application are described in detail below with reference to the embodiments.

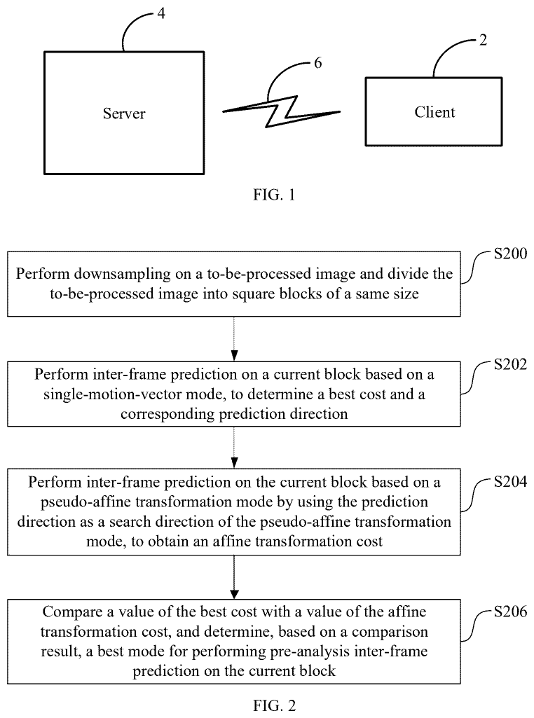

FIG. 1 is a diagram of an architecture of an application environment for implementing the embodiments of the application. The application may be applied to an application environment that includes but is not limited to a client 2, a server 4, and a network 6.

The client 2 is configured to display an interface of a current application to a user and receive operations of the user, such as uploading and selecting a video or an image. The client 2 may be a terminal device, for example, a personal computer (PC), a mobile phone, a tablet computer, a portable computer, or a wearable device.

The server 4 is configured to provide data and technical support for the client 2. The server 4 may be a computing device such as a rack server, a blade server, a tower server, or a cabinet server, may be an independent server, or may be a server cluster including a plurality of servers.

The network 6 may be a wireless or wired network, for example, an Intranet, the Internet, a global system for mobile communication (GSM), wideband code division multiple access (WCDMA), a 4G network, a 5G network, Bluetooth, or Wi-Fi. The server 4 is communicatively connected to one or more clients 2 by using the network 6, to perform data transmission and exchange.

### Embodiment 1

FIG. 2 is a flowchart of an image pre-analysis method according to Embodiment 1 of the application. It may be understood that the flowchart in the method embodiment is not used to limit a sequence of performing steps. Some steps in the flowchart may alternatively be added or deleted as required. The method may be performed by a client or a server, which is not limited herein. Specifically, the method is applied to a pre-analysis module of an encoder.

The method includes the following steps.

S200: Perform downsampling on a to-be-processed image, and divide the to-be-processed image into square blocks of a same size.

First, in the pre-analysis module of the encoder, it is a common practice to perform downsampling on an image and divide the image into square blocks of a same size for processing. A side length of the square block is denoted as w. When a side length w of the square obtained through division in pre-analysis is greater than or equal to 8, in the solution provided in the embodiment of the application, processing of subsequent steps is performed on the image.

S202: Perform inter-frame prediction on a current block based on a single-motion-vector mode, to determine a best cost and a corresponding prediction direction.

After a pre-analysis inter-frame prediction part is entered, motion estimation is first performed on the current block based on a conventional motion estimation algorithm, that is, the single-motion-vector mode, to determine rate distortion costs predicted in forward, backward and bi-directional. Then, the rate distortion costs in each prediction direction are compared to obtain the best cost. A prediction direction corresponding to the best cost is recorded, and the best cost is denoted as bestCost.

S204: Perform inter-frame prediction on the current block based on a pseudo-affine transformation mode by using the prediction direction as a search direction of the pseudo-affine transformation mode, to obtain an affine transformation cost.

Because the prediction direction corresponding to the best cost of the single-motion-vector mode may be forward, backward, or bi-directional, the search direction of the pseudo-affine transformation mode may also correspondingly be forward, backward, or bi-directional.

Taking the search direction as forward as an example, subsequent steps of the embodiment are described in detail below. When the prediction direction corresponding to the best cost of the single-motion-vector mode is forward, a search direction of pseudo-affine transformation is set to forward, and a reference frame is a reference frame refframe corresponding to forward prediction.

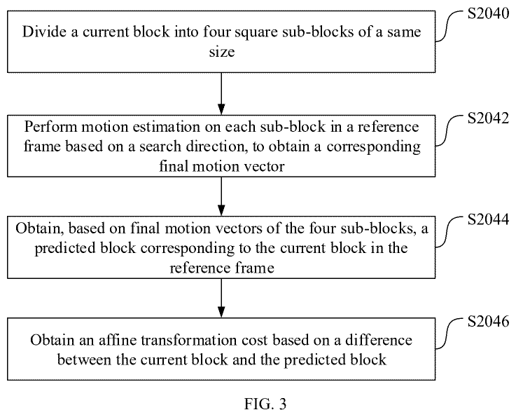

Specifically, further referring to FIG. 3, FIG. 3 is a detailed schematic flowchart of the foregoing step S204. It may be understood that this flowchart is not used to limit a sequence of performing steps. Some steps in the flowchart may alternatively be added or deleted as required. In the embodiment, step S204 specifically includes the following steps.

S2040: Divide the current block into four square sub-blocks of a same size.

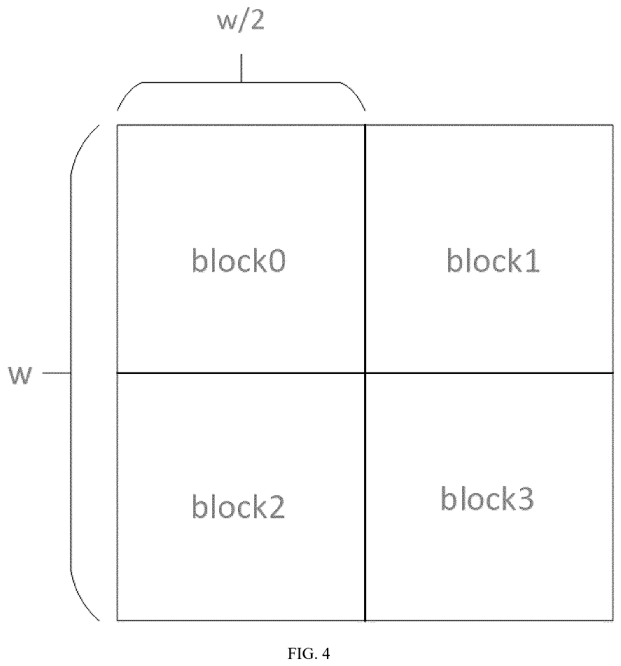

Specifically, a current square block whose side length is w is divided into four square sub-blocks whose side lengths are w/2, and the four square sub-blocks are respectively denoted as block0, block1, block2, and block3. FIG. 4 is a schematic diagram of the four square sub-blocks.

S2042: Perform motion estimation on each sub-block in a reference frame based on the search direction, to obtain a corresponding final motion vector.

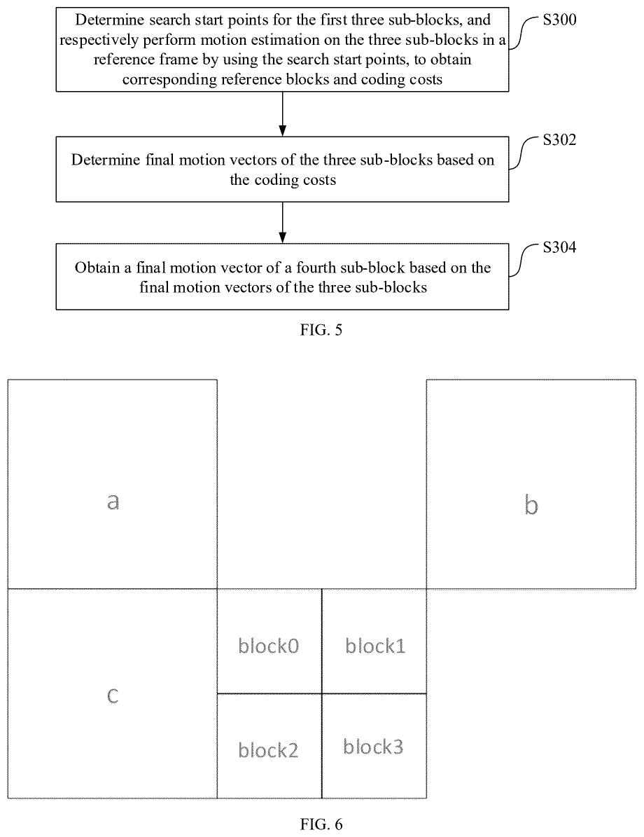

Specifically, further referring to FIG. 5, FIG. 5 is a detailed schematic flowchart of the foregoing step S2042. It may be understood that this flowchart is not used to limit a sequence of performing steps. Some steps in the flowchart may alternatively be added or deleted as required. In the embodiment, step S2042 specifically includes the following steps.

S300: Determine search start points for first three sub-blocks, and respectively perform motion estimation on the three sub-blocks in the reference frame by using the search start points, to obtain corresponding reference blocks and coding costs.

The four sub-blocks in FIG. 4 are used as an example. The first three sub-blocks are three sub-blocks block0, block1, and block2 in upper left, upper right, and lower left of FIG. 4. First, search start points for the three sub-blocks are determined. FIG. 6 is a schematic diagram of a search start point for each sub-block. Specifically, the sub-block block0 uses a motion vector mva, obtained by a block a at an upper left corner of the current block during a forward search, as a search start point, the sub-block block1 uses a motion vector mvb, obtained by a block b at an upper right corner of the current block during a forward search, as a search start point, and the sub-block block2 uses a motion vector mvc, obtained by a block c on a left side of the current block during a forward search, as a search start point.

Then, motion estimation is respectively performed on the three sub-blocks in the reference frame refframe by using the start search points, to obtain corresponding reference blocks and coding costs. For example, for the sub-blocks block0, block1, and block2, corresponding reference blocks refblock0, refblock1, and refblock2 are obtained, and a coding cost between each sub-block and a corresponding reference block is calculated. In the embodiment, the coding cost is represented by SATD, and is denoted as satdcost.

S302: Determine final motion vectors of the three sub-blocks based on the coding costs.

In the embodiment, this step includes two cases:

(1) When the coding costs are less than or equal to a specified threshold (affineSearchSkipThreshold), the search start points are used as the final motion vectors of the sub-blocks.

For example, for the foregoing three sub-blocks block0, block1, and block2, if satdcost calculated in the previous step is less than or equal to the threshold affineSearchSkipThreshold, the search start points mva, mvb, and mvc are final motion vectors of the corresponding sub-blocks.

(2) When the coding costs are greater than the specified threshold, a hexagon-based search is performed based on the search start points, to obtain the final motion vectors of the sub-blocks.

A hexagon-based search (HEXBS) algorithm is a classical block matching motion estimation algorithm. Based on the hexagon-based search algorithm, a search is performed from the search start point corresponding to the sub-block to obtain a final motion vector of the sub-block. Details are not described herein again.

S304: Obtain a final motion vector of a fourth sub-block based on the final motion vectors of the three sub-blocks.

For example, it is assumed that final motion vectors obtained by the first three sub-blocks block0, block1, and block2 are respectively mva, mvb, and mvc, and mva=(mvahor, mvaver), mvb=(mvbhor, mvbver), and mvc=(mvchor, mvcver), two components in the parentheses respectively represent a horizontal component and a vertical component of a corresponding motion vector. The final motion vector mvd corresponding to the fourth sub-block block3 may be calculated based on the following formulas:

$$mvd = ( mvdhor , mvdver ) ;$$

$$mvdhor = mvchor + mvbhor - mvahor ;$$

$$mvdver = mvbver + mvcver - mvaver .$$

Return to FIG. 3. S2044: Obtain, based on final motion vectors of the four sub-blocks, a predicted block corresponding to the current block in the reference frame.

In the embodiment, four predicted sub-blocks respectively pointed to by the final motion vectors of the four sub-blocks in the reference frame are obtained, and then the four predicted sub-blocks are spliced to obtain the predicted block corresponding to the current block.

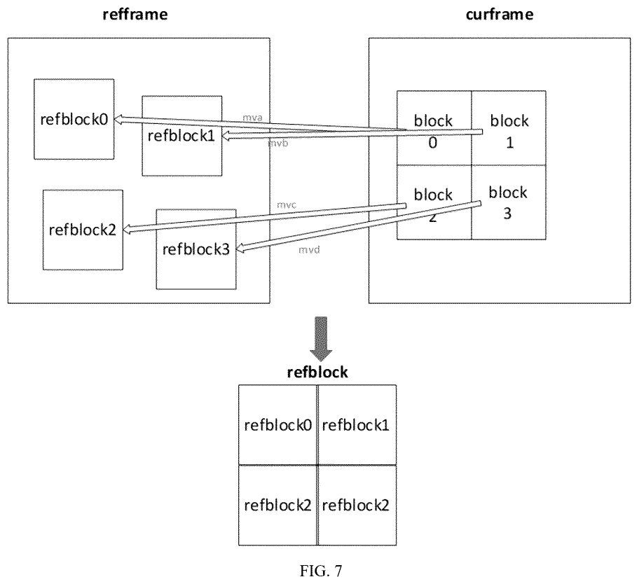

For example, corresponding predicted sub-blocks refblock0, refblock1, refblock2, and refblock3 of the four sub-blocks block0, block1, block2, and block 3 in the reference frame refframe are obtained based on the final motion vectors mva, mvb, mvc, and mvd of the four sub-blocks block0, block1, block2, and block 3 that are respectively obtained by using the foregoing steps, and the predicted sub-blocks refblock0, refblock1, refblock2, and refblock3 are spliced into a final predicted block refblock. FIG. 7 is a schematic diagram of a process of obtaining the predicted block.

S2046: Obtain the affine transformation cost based on a difference between the current block and the predicted block.

After the predicted block corresponding to the current block is obtained, a difference value, that is, the affine transformation cost between the predicted block and the current block is calculated. In the embodiment, the affine transformation cost is also represented by SATD, and is denoted as affineSatdCost.

Return to FIG. 2. S206: Compare a value of the best cost with a value of the affine transformation cost, and determine, based on a comparison result, a best mode for performing pre-analysis inter-frame prediction on the current block.

In the embodiment, when the value of the best cost is greater than or equal to the value of the affine transformation cost, the best mode is the pseudo-affine transformation mode. Otherwise, when the value of the best cost is less than the value of the affine transformation cost, the best mode is the single-motion-vector mode.

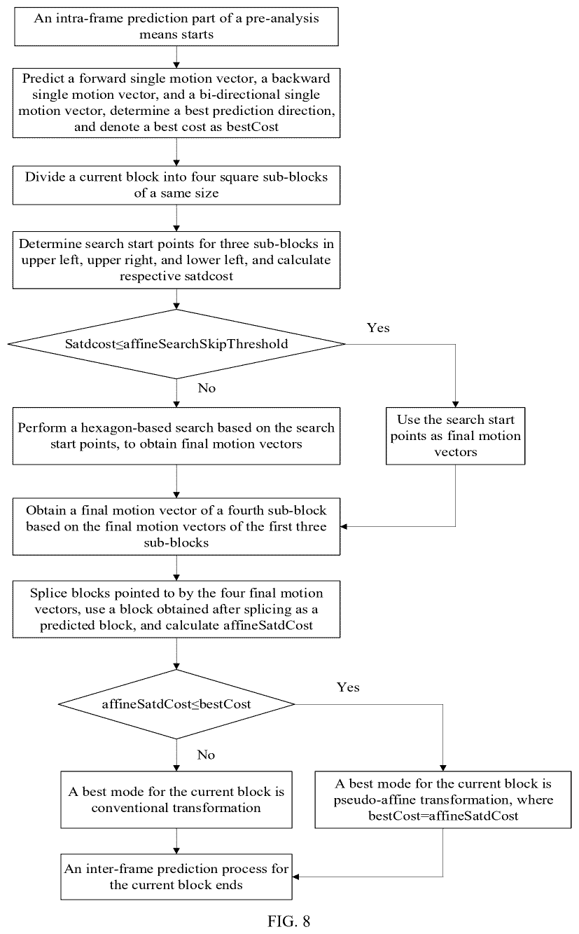

FIG. 8 is a schematic flowchart of another form of the image pre-analysis method in the embodiment when the search direction is forward. A specific implementation process of steps in FIG. 8 has been described above, and details are not described herein again.

In addition, if the prediction direction corresponding to the best cost is backward, a predicted block for pseudo-affine transformation is also obtained in a backward reference frame for the current block based on the foregoing process, and a value of an affine transformation cost of the predicted block is compared with that of the best cost. If a cost of backward pseudo-affine transformation is relatively small, the best mode obtained by the current block in the pre-analysis module is a backward pseudo-affine transformation mode.

If the prediction direction corresponding to the best cost is bi-directional, predicted blocks refblockForward and refblockBackward of respective pseudo-affine transformation modes are also obtained for the current block in a forward reference frame and a backward reference frame based on the foregoing process. A predicted block refblock finally obtained for the current block=(refblockForward+refblockBackward)>>1, and a cost of bidirectional pseudo-affine transformation is calculated based on the predicted block and is compared with the best cost. If the cost of the bidirectional pseudo-affine transformation is relatively small, the best mode for the current block in the pre-analysis module is a bidirectional pseudo-affine transformation mode.

In addition, for a square block for which a best mode is the pseudo-affine transformation mode, when a propagation distortion cost is calculated in the pre-analysis module, the square block also needs to be divided into four square sub-blocks of a same size, and propagation distortion costs are respectively calculated based on final motion vectors obtained in pseudo-affine transformation.

In the image pre-analysis method provided in the embodiment, a pseudo-affine transformation mode applicable to a pre-analysis module is provided, so as to imitate a prediction manner of an affine transformation mode of a primary encoder module to some extent, improve accuracy of inter-frame prediction of the pre-analysis module at relatively small complexity overheads, improve consistency between a prediction result of the pre-analysis module and a prediction result of the primary encoder module, improve efficiency of the pre-analysis module, and provide better guidance for behavior of the primary encoder module, thereby improving performance of an involved scene detection module, an adaptive frame type module, and a cutree module. In addition, a best mode suitable for performing inter-frame prediction on a current block by the pre-analysis module may be flexibly selected based on comparison between a prediction cost obtained when the current block uses a single-motion-vector mode and a prediction cost obtained when the current block uses the pseudo-affine transformation mode, so as to reduce the prediction cost and improve compression efficiency.

### Embodiment 2

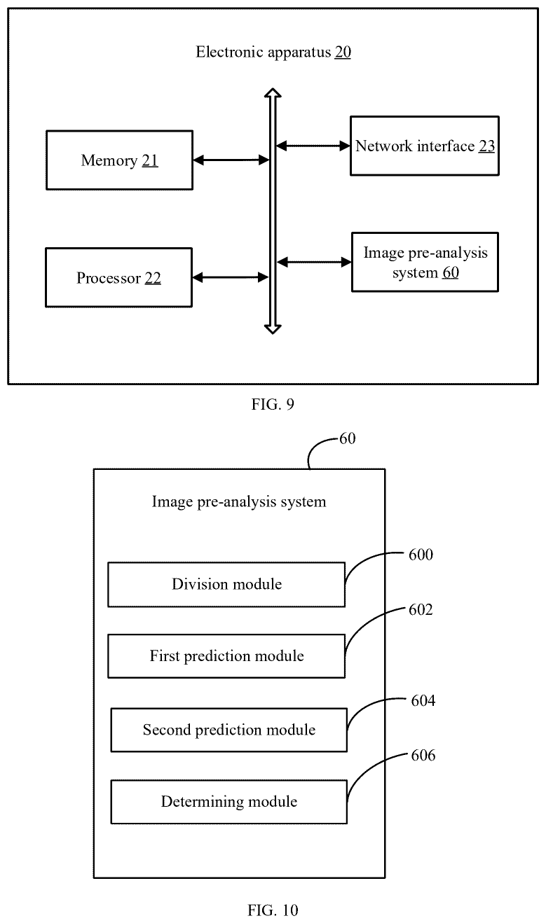

FIG. 9 is a schematic diagram of a hardware architecture of an electronic apparatus 20 according to Embodiment 2 of the application. In the embodiment, the electronic apparatus 20 may include but is not limited to a memory 21, a processor 22, and a network interface 23 that may be communicatively connected to each other by using a system bus. It should be noted that FIG. 9 merely shows the electronic apparatus 20 with the components 21 to 23. However, it should be understood that implementation of all the shown components is not required, and more or fewer components may alternatively be implemented. In the embodiment, the electronic apparatus 20 may be an apparatus of a client or a server.

The memory 21 includes at least one type of readable storage medium. The readable storage medium includes a flash memory, a hard disk, a multimedia card, a card-type memory (for example, an SD memory or a DX memory), a random access memory (RAM), a static random access memory (SRAM), a read-only memory (ROM), an electrically erasable programmable read-only memory (EEPROM), a programmable read-only memory (PROM), a magnetic memory, a magnetic disk, an optical disc, and the like. In some embodiments, the memory 21 may be an internal storage unit of the electronic apparatus 20, for example, a hard disk or a memory of the electronic apparatus 20. In some other embodiments, the memory 21 may alternatively be an external storage device of the electronic apparatus 20, for example, a removable hard disk, a smart media card (SMC), a secure digital (SD) card, or a flash card that is disposed on the electronic apparatus 20. Certainly, the memory 21 may include both the internal storage unit of the electronic apparatus 20 and the external storage device of the electronic apparatus 20. In the embodiment, the memory 21 is usually configured to store an operating system and various types of application software that are installed in the electronic apparatus 20, for example, program code of an image pre-analysis system 60. In addition, the memory 21 may be further configured to temporarily store various types of data that have been output or are to be output.

In some embodiments, the processor 22 may be a central processing unit (CPU), a controller, a microcontroller, a microprocessor, or another data processing chip. The processor 22 is usually configured to control an overall operation of the electronic apparatus 20. In the embodiment, the processor 22 is configured to run the program code stored in the memory 21 or process data, for example, run the image pre-analysis system 60.

The network interface 23 may include a wireless network interface or a wired network interface, and the network interface 23 is usually configured to establish a communication connection between the electronic apparatus 20 and another electronic device.

### Embodiment 3

FIG. 10 is a schematic diagram of modules of an image pre-analysis system 60 according to Embodiment 3 of the application. The image pre-analysis system 60 may be divided into one or more program modules. The one or more program modules are stored in a storage medium and executed by one or more processors, to complete the embodiment of the application. The program module in the embodiment of the application is a series of computer program instruction segments that can be used to complete a specified function. A function of each program module in the embodiment is to be described in detail below.

In the embodiment, the image pre-analysis system 60 includes a division module 600, a first prediction module 602, a second prediction module 604, and a determining module 606.

The division module 600 is configured to perform downsampling on a to-be-processed image, and divide the to-be-processed image into square blocks of a same size.

It is a common practice to perform downsampling on an image and divide the image into square blocks of a same size. A side length of the square block is denoted as w, and w is greater than or equal to 8.

The first prediction module 602 is configured to perform inter-frame prediction on a current block based on a single-motion-vector mode, to determine a best cost and a corresponding prediction direction.

After entering a pre-analysis inter-frame prediction part, the first prediction module 602 first performs motion estimation on the current block based on a conventional motion estimation algorithm, that is, the single-motion-vector mode, to determine rate distortion costs predicted in forward, backward and bi-directional. Then, the rate distortion costs in each prediction direction are compared to obtain the best cost. A prediction direction corresponding to the best cost is recorded, and the best cost is denoted as bestCost.

The second prediction module 604 is configured to perform inter-frame prediction on the current block based on a pseudo-affine transformation mode by using the prediction direction as a search direction of the pseudo-affine transformation mode, to obtain an affine transformation cost.

Because the prediction direction corresponding to the best cost of the single-motion-vector mode may be forward, backward, or bi-directional, the search direction of the pseudo-affine transformation mode may also correspondingly be forward, backward, or bi-directional. For example, the search direction is forward, and a reference frame is a reference frame refframe corresponding to forward prediction.

First, the current block is divided into four square sub-blocks of a same size.

Then, motion estimation is performed on each sub-block in the reference frame based on the search direction, to obtain a corresponding final motion vector.

(1) Search start points for first three sub-blocks are determined, and motion estimation is respectively performed on the three sub-blocks in the reference frame by using the search start points, to obtain corresponding reference blocks and coding costs. In the embodiment, the coding cost is represented by SATD, and is denoted as satdcost.

(2) Final motion vectors of the three sub-blocks are determined based on the coding costs. In this case, there are two cases:

(2-1) When the coding costs are less than or equal to a specified threshold, the search start points are used as the final motion vectors of the sub-blocks.

(2-2) When the coding costs are greater than the specified threshold, a hexagon-based search is performed based on the search start points, to obtain the final motion vectors of the sub-blocks.

(3) A final motion vector of a fourth sub-block is obtained based on the final motion vectors of the three sub-blocks.

Then, a predicted block corresponding to the current block in the reference frame is obtained based on the final motion vectors of the four sub-blocks.

In the embodiment, four predicted sub-blocks respectively pointed to by the final motion vectors of the four sub-blocks in the reference frame are obtained, and then the four predicted sub-blocks are spliced to obtain the predicted block corresponding to the current block.

Finally, the affine transformation cost is obtained based on a difference between the current block and the predicted block.

After the predicted block corresponding to the current block is obtained, a difference value, that is, the affine transformation cost between the predicted block and the current block is calculated. In the embodiment, the affine transformation cost is also represented by SATD, and is denoted as affineSatdCost.

The determining module 606 is configured to: compare a value of the best cost with a value of the affine transformation cost, and determine, based on a comparison result, a best mode for performing pre-analysis inter-frame prediction on the current block.

In the embodiment, when the value of the best cost is greater than or equal to the value of the affine transformation cost, the best mode is the pseudo-affine transformation mode. Otherwise, when the value of the best cost is less than the value of the affine transformation cost, the best mode is the single-motion-vector mode.

In addition, if the prediction direction corresponding to the best cost is backward, a predicted block for pseudo-affine transformation is also obtained in a backward reference frame for the current block based on the foregoing process, and a value of an affine transformation cost of the predicted block is compared with that of the best cost. If a cost of backward pseudo-affine transformation is relatively small, the best mode obtained by the current block in the pre-analysis module is a backward pseudo-affine transformation mode.

If the prediction direction corresponding to the best cost is bi-directional, predicted blocks refblockForward and refblockBackward of respective pseudo-affine transformation modes are also obtained for the current block in a forward reference frame and a backward reference frame based on the foregoing process. A predicted block refblock finally obtained for the current block=(refblockForward+refblockBackward)>>1, and a cost of bidirectional pseudo-affine transformation is calculated based on the predicted block and is compared with the best cost. If the cost of the bidirectional pseudo-affine transformation is relatively small, the best mode for the current block in the pre-analysis module is a bidirectional pseudo-affine transformation mode.

In addition, for a square block for which a best mode is the pseudo-affine transformation mode, when a propagation distortion cost is calculated in the pre-analysis module, the square block also needs to be divided into four square sub-blocks of a same size, and propagation distortion costs are respectively calculated based on final motion vectors obtained in pseudo-affine transformation.

In the image pre-analysis system provided in the embodiment, a pseudo-affine transformation mode applicable to a pre-analysis module is provided, so as to imitate a prediction manner of an affine transformation mode of a primary encoder module to some extent, improve accuracy of inter-frame prediction of the pre-analysis module at relatively small complexity overheads, improve consistency between a prediction result of the pre-analysis module and a prediction result of the primary encoder module, improve efficiency of the pre-analysis module, and provide better guidance for the primary encoder module, thereby improving performance of an involved scene detection module, an adaptive frame type module, and a cutree module. In addition, a best mode suitable for performing inter-frame prediction on a current block by the pre-analysis module may be flexibly selected based on comparison between a prediction cost obtained when the current block uses a single-motion-vector mode and a prediction cost obtained when the current block uses the pseudo-affine transformation mode, so as to reduce the prediction cost and improve compression efficiency.

### Embodiment 4

The application further provides another implementation, that is, provides a computer-readable storage medium. The computer-readable storage medium stores an image pre-analysis program. The image pre-analysis program may be executed by at least one processor, to enable the at least one processor to perform the steps of the image pre-analysis method.

In the embodiment, the computer-readable storage medium includes a flash memory, a hard disk, a multimedia card, a card-type memory (for example, an SD memory or a DX memory), a random access memory (RAM), a static random access memory (SRAM), a read-only memory (ROM), an electrically erasable programmable read-only memory (EEPROM), a programmable read-only memory (PROM), a magnetic memory, a magnetic disk, an optical disc, or the like. In some embodiments, the computer-readable storage medium may be an internal storage unit of a computer device, for example, a hard disk or an internal memory of the computer device. In some other embodiments, the computer-readable storage medium may be an external storage device of the computer device, for example, a removable hard disk, a smart media card (SMC), a secure digital (SD) card, or a flash card that is disposed on the computer device. Certainly, the computer-readable storage medium may alternatively include both the internal storage unit of the computer device and the external storage device of the computer device. In the embodiment, the computer-readable storage medium is usually configured to store an operating system and various application software that are installed on the computer device, for example, program code of the image pre-analysis method in the embodiments. In addition, the computer-readable storage medium may be further configured to temporarily store various types of data that have been output or are to be output.

### Embodiment 5

The application further provides a computer program product. The computer program product stores an image pre-analysis program, and the image pre-analysis program may be executed by at least one processor, to enable the at least one processor to perform the steps of the foregoing image pre-analysis method.

It should be noted that in this specification, the term “include”, “comprise”, or any other variant thereof is intended to cover non-exclusive inclusion, so that a process, method, article, or apparatus that includes a series of elements includes those elements and other elements that are not explicitly listed or elements inherent to the process, method, article, or apparatus. In the absence of more restrictions, the element defined with the statement “includes a . . . ” does not exclude the existence of another identical element in the process, method, article, or apparatus that includes the element.

The serial numbers of the foregoing embodiments of the application are merely for illustrative purposes, and are not intended to indicate priorities of the embodiments.

Clearly, a person skilled in the art should understand that the foregoing modules or steps in the embodiments of the application may be implemented by using a general computing apparatus. The modules or steps may be integrated into a single computing apparatus or distributed in a network including a plurality of computing apparatuses. Optionally, the modules or steps may be implemented by using program code that can be executed by the computing apparatus. Therefore, the modules or steps may be stored in a storage apparatus for execution by the computing apparatus. In addition, in some cases, the shown or described steps may be performed in an order different from the order herein. Alternatively, the modules or steps are separately made into integrated circuit modules, or a plurality of modules or steps in the modules or steps are made into a single integrated circuit modules for implementation. In this way, a combination of any specific hardware and software is not limited in the embodiments of the application.

The foregoing descriptions are merely preferred embodiments in the embodiments of the application, and are not intended to limit the patent scope of the embodiments of the application. Any equivalent structure or equivalent procedure change that is made by using the content of the specification and the accompanying drawings of the embodiments of the application or that is directly or indirectly applied to other related technical fields shall also fall within the patent protection scope of the embodiments of the application.

What is claimed is:

1. An image pre-analysis method, applied to a pre-analysis module of an encoder, wherein the method comprises:
performing downsampling on a to-be-processed image, and dividing the to-be-processed image into square blocks of a same size;
performing inter-frame prediction on a current block based on a single-motion-vector mode, to determine a best cost and a corresponding prediction direction;
performing inter-frame prediction on the current block based on a pseudo-affine transformation mode by using the prediction direction as a search direction of the pseudo-affine transformation mode, to obtain an affine transformation cost; and
comparing a value of the best cost with a value of the affine transformation cost, and determining, based on a comparison result, a best mode for performing pre-analysis inter-frame prediction on the current block.

2. The image pre-analysis method according to claim 1, wherein the performing inter-frame prediction on a current block based on a single-motion-vector mode, to determine a best cost and a corresponding prediction direction comprises:
performing motion estimation on the current block based on the single-motion-vector mode, to determine rate distortion costs predicted in forward, backward and bi-directional; and
comparing the rate distortion costs of each prediction direction to obtain the best cost and a prediction direction corresponding to the best cost.

3. The image pre-analysis method according to claim 1, wherein the performing inter-frame prediction on the current block based on a pseudo-affine transformation mode by using the prediction direction as a search direction of the pseudo-affine transformation mode, to obtain an affine transformation cost comprises:
dividing the current block into four square sub-blocks of a same size;
performing motion estimation on each sub-block in a reference frame based on the search direction, to obtain a corresponding final motion vector;
obtaining, based on final motion vectors of the four sub-blocks, a predicted block corresponding to the current block in the reference frame; and
obtaining the affine transformation cost based on a difference between the current block and the predicted block.

4. The image pre-analysis method according to claim 3, wherein the performing motion estimation on each sub-block in a reference frame based on the search direction, to obtain a corresponding final motion vector comprises:
determining search start points for first three sub-blocks, and respectively performing motion estimation on the three sub-blocks in the reference frame by using the search start points, to obtain corresponding reference blocks and coding costs;
determining final motion vectors of the three sub-blocks based on the coding costs; and
obtaining a final motion vector of a fourth sub-block based on the final motion vectors of the three sub-blocks.

5. The image pre-analysis method according to claim 4, wherein the determining final motion vectors of the three sub-blocks based on the coding costs comprises:
when the coding costs are less than or equal to a specified threshold, using the search start points as the final motion vectors of the sub-blocks.

6. The image pre-analysis method according to claim 5, wherein the determining final motion vectors of the three sub-blocks based on the coding costs comprises:
when the coding costs are greater than the specified threshold, performing a hexagon-based search based on the search start points, to obtain the final motion vectors of the sub-blocks.

7. The image pre-analysis method according to claim 3, wherein the obtaining, based on final motion vectors of the four sub-blocks, a predicted block corresponding to the current block in the reference frame comprises:
obtaining four predicted sub-blocks respectively pointed to by the final motion vectors of the four sub-blocks in the reference frame; and
splicing the four predicted sub-blocks to obtain the predicted block corresponding to the current block.

8. The image pre-analysis method according to claim 1, wherein the determining, based on a comparison result, a best mode for performing pre-analysis inter-frame prediction on the current block comprises:
when the value of the best cost is greater than or equal to the value of the affine transformation cost, determining the best mode is the pseudo-affine transformation mode; and
when the value of the best cost is less than the value of the affine transformation cost, determining the best mode is the single-motion-vector mode.

9. An image pre-analysis system, applied to a pre-analysis module of an encoder, wherein the system comprises:
a division module, configured to perform downsampling on a to-be-processed image, and divide the to-be-processed image into square blocks of a same size;
a first prediction module, configured to perform inter-frame prediction on a current block based on a single-motion-vector mode, to determine a best cost and a corresponding prediction direction;
a second prediction module, configured to perform inter-frame prediction on the current block based on a pseudo-affine transformation mode by using the prediction direction as a search direction of the pseudo-affine transformation mode, to obtain an affine transformation cost; and
a determining module, configured to compare a value of the best cost with a value of the affine transformation cost, and determine, based on a comparison result, a best mode for performing pre-analysis inter-frame prediction on the current block.

10. An electronic apparatus, wherein the electronic apparatus comprises a memory, a processor, and a program stored in the memory and capable of running on the processor, and the program, when executed by the processor, cause the processor to implement operations comprising:
performing downsampling on a to-be-processed image, and dividing the to-be-processed image into square blocks of a same size;
performing inter-frame prediction on a current block based on a single-motion-vector mode, to determine a best cost and a corresponding prediction direction;
performing inter-frame prediction on the current block based on a pseudo-affine transformation mode by using the prediction direction as a search direction of the pseudo-affine transformation mode, to obtain an affine transformation cost; and
comparing a value of the best cost with a value of the affine transformation cost, and determining, based on a comparison result, a best mode for performing pre-analysis inter-frame prediction on the current block.

11. The electronic apparatus according claim 10, wherein the performing inter-frame prediction on a current block based on a single-motion-vector mode, to determine a best cost and a corresponding prediction direction comprises:
performing motion estimation on the current block based on the single-motion-vector mode, to determine rate distortion costs predicted in forward, backward and bi-directional; and
comparing the rate distortion costs of each prediction direction to obtain the best cost and a prediction direction corresponding to the best cost.

12. The electronic apparatus according claim 10, wherein the performing inter-frame prediction on the current block based on a pseudo-affine transformation mode by using the prediction direction as a search direction of the pseudo-affine transformation mode, to obtain an affine transformation cost comprises:
dividing the current block into four square sub-blocks of a same size;
performing motion estimation on each sub-block in a reference frame based on the search direction, to obtain a corresponding final motion vector;
obtaining, based on final motion vectors of the four sub-blocks, a predicted block corresponding to the current block in the reference frame; and
obtaining the affine transformation cost based on a difference between the current block and the predicted block.

13. The electronic apparatus according claim 12, wherein the performing motion estimation on each sub-block in a reference frame based on the search direction, to obtain a corresponding final motion vector comprises:
determining search start points for first three sub-blocks, and respectively performing motion estimation on the three sub-blocks in the reference frame by using the search start points, to obtain corresponding reference blocks and coding costs;
determining final motion vectors of the three sub-blocks based on the coding costs; and
obtaining a final motion vector of a fourth sub-block based on the final motion vectors of the three sub-blocks.

14. The electronic apparatus according claim 13, wherein the determining final motion vectors of the three sub-blocks based on the coding costs comprises:
when the coding costs are less than or equal to a specified threshold, using the search start points as the final motion vectors of the sub-blocks.

15. The electronic apparatus according claim 14, wherein the determining final motion vectors of the three sub-blocks based on the coding costs comprises:
when the coding costs are greater than the specified threshold, performing a hexagon-based search based on the search start points, to obtain the final motion vectors of the sub-blocks.

16. The electronic apparatus according claim 12, wherein the obtaining, based on final motion vectors of the four sub-blocks, a predicted block corresponding to the current block in the reference frame comprises:
obtaining four predicted sub-blocks respectively pointed to by the final motion vectors of the four sub-blocks in the reference frame; and
splicing the four predicted sub-blocks to obtain the predicted block corresponding to the current block.

17. The electronic apparatus according claim 10, wherein the determining, based on a comparison result, a best mode for performing pre-analysis inter-frame prediction on the current block comprises:
when the value of the best cost is greater than or equal to the value of the affine transformation cost, determining the best mode is the pseudo-affine transformation mode; and
when the value of the best cost is less than the value of the affine transformation cost, determining the best mode is the single-motion-vector mode.

18. A non-transitory computer-readable storage medium, wherein the non-transitory computer-readable storage medium stores a computer program, and when the computer program is executed by a processor, the image pre-analysis method according to claim 1 is implemented.

19. A computer program product, wherein the computer program product stores a computer program, and when the computer program is executed by a processor, the image pre-analysis method according to claim 1 is implemented.

20. The computer program product according to claim 19, wherein the performing inter-frame prediction on a current block based on a single-motion-vector mode, to determine a best cost and a corresponding prediction direction comprises:
performing motion estimation on the current block based on the single-motion-vector mode, to determine rate distortion costs predicted in forward, backward and bi-directional; and
comparing the rate distortion costs of each prediction direction to obtain the best cost and a prediction direction corresponding to the best cost.
